(19) United States
(12) Patent Application Publication
(10) Pub. No.: US 2006/0007948 A1
(43) Pub. Date: Jan. 12, 2006

(54) Personal code registration and use method and service system, using telecommunication network

(76) Inventor: Byoung-Whang Cho, Seoul-city (KR)

Correspondence Address: SHERMAN D PERNIA, ESQ., PC, 1110 NASA ROAD ONE, SUITE 450, HOUSTON, TX, 77058-3310, US

(21) Appl. No.: 10/938,678

(22) Filed: Sep. 11, 2004

(30) Foreign Application Priority Data
Jun. 14, 2004 (KR) 10-2004-0043483

(51) Int. Cl. H04B 7/216

(52) U.S. Cl. 370/441

(57) ABSTRACT

The personal code registration and use method and the service system therefor, through a telecommunication network, are provided. In the personal code registering method it is checked whether there is generated a code registration request from a subscriber terminal connected to the telecommunication network. When the code registration request is generated, subscriber information is received and the personal code is generated. If the generated personal code corresponds to a new code, a code registration and storage for the generated personal code is performed. Thereby, a peculiar identification code can be adequately used to applicable things, substantially reducing a leakage of personal information. Also, peculiarity and difference for possessed goods are provide to enhance a sale promotion and brand image, and subscriber information can be grasped through a code operating server only in an extremely limited case, such that an identification clarification is promptly performed under a special status such as an unconscious state.

### BACKGROUND OF THE INVENTION

1. Field of the Invention

This disclosure relates to a personal code registration and use method and a service system, using a telecommunication network.

2. Description of the Related Art

In general a peculiar code such as a resident registration number etc. is given to respective individuals, together with their birth, one by one. When respective examinees applying for an examination like a driving test and successfully pass the examination by satisfying necessary requirements, driving licenses are each given to the examinees. However, the peculiar codes such as the resident registration number or the driving license number etc. can be principally used only domestically, thus there is a difficulty in a worldwide common use. Furthermore, it is undesirable to represent oneself resident registration number or name on oneself possession goods such as automobile, watch, clothes or portable telephone etc. in order to prove oneself possession goods, because others may use it by stealth without permission of the owner thus concerned party who has executed an indication operation on the possession goods may be damaged.

Thus it is required to provide a code giving/registration and its management system in a real life, in which a code of indicating peculiarity and difference of oneself possession goods is stuck thereto and simultaneously personal information is not easily leaked to others.

Also, in case a peculiar code is stuck to or is shown on the goods, not only sales promotion or brand image increases, but also it is easy to recover the lost or robbed possession goods, that is, the code giving and registration based on a new system through a telecommunication network is required.

In the meantime, subscriber information can be grasped only in an extremely limited case, through personal codes represented on possession goods, thus an identification clarification can be promptly obtained through a code operating server when a special status like generation of death, unidentified or unconscious state etc. is caused. That is, it is the status of essentially requiring a personal/group code granting and registration and its operating method via on line, the code being not leaked to general others.

### SUMMARY OF THE INVENTION

Embodiments of the invention provide a personal code registration and use method and a service system therefor, using telecommunication network, in which a peculiar identification code can be efficiently used to applicable things such as famed products etc., substantially reducing a leakage of personal information. The method and system provide peculiarity and difference of possession goods by indicating a registered peculiar code on the possession goods, thereby enhancing sales promotion or brand image.

Embodiments of the invention provide a personal code registration and use method and a service system, which can increase an easiness to recover possessed things lost or robbed, and which can promptly clarify an identification through a code operating server under a special status such as death, unidentified or unconscious state etc. by grasping subscriber information only under an extremely limited case through a personal code indicated on possessed goods.

According to one aspect of the invention, a method of registering a personal code through telecommunication network includes checking whether there is generated a code registration request from a subscriber terminal connected to the telecommunication network; receiving subscriber information if the code registration request was generated, and generating a personal code; and performing a code registration and storage for the generated personal code if the generated personal code corresponds to a new code.

The registered personal code may desirably be a uniquely existing code domestically or worldwide, and the registration of personal code can be operated by pay through a member joining. Also, the personal code may be using extendable to couple, family or group without limiting only to an individual.

According to another aspect of the invention, a method of registering and operating a personal code through a telecommunication network includes checking whether there is generated a code registration request from a subscriber terminal connected to the telecommunication network, the code registration request being for requiring a registration of code representing a possession; receiving subscriber information when the code registration request is generated, and automatically or manually generating a code conformed to a certification format; performing a code registration and storage for the generated code if the generated code corresponds to a new code; checking whether to apply the code to a product when an order for the product is requested from the subscriber terminal; receiving a code registration clarification and code sticking/indication information if the code is applied to the product; providing a virtual image for which the code was applied to the product, through a screen, in compliance with the code sticking/indication information; and transmitting code information, and information related with the code sticking/indication and manufacture, to a product manufacturer server, when a payment for the ordered product was completed.

The order for product may be desirably applicable to all goods for sale through Internet, and the registered code may be basically configured by a composition of national code, sexual code and identification code. Also, the registered code may further include an area code.

Another aspect of the invention provides a code registration and service system for operating the code through a telecommunication network, including a subscriber terminal connected through the telecommunication network, and a code operating server. The code operating server performs a code registration and storage when there is generated a code registration request from the subscriber terminal, the code registration request being for requiring a registration of code to be used to represent a possession. Then, the code operating server receives code registration clarification and code sticking/indication information when an order of product for a code application is requested, and provides a virtual image through a screen. Next, the code operating server transmits code information, and information related with the code sticking and indication and manufacture, to a product manufacturer server.

The code registration and service system may further include an information storing unit that is connected to the code operating server and that accumulatively stores subscriber data for the code registration and storage.

The inventive method and system substantially reduce a leakage of personal information, together with a proper use of peculiar identification code to an applicable thing. Thus, peculiarity and difference of possession goods are provided by indicating the registered personal code on the goods, not only enhancing sales promotion or brand image but also increasing a recovery easiness for lost or robbed goods. Furthermore, subscriber information can be grasped by the code operating server through a code indicated on the possession goods only under an extremely limited case, thereby promptly executing an identification clarification under a special status such as unconsciousness state etc.

### BRIEF DESCRIPTION OF THE DRAWINGS

The above and other features of exemplary embodiments of the invention will become readily apparent from the description that follows, with reference to the attached drawings in which:

FIG. 1 is a block diagram entirely illustrating a telecommunication network system containing a code registration and service system according to an exemplary embodiment of the present invention;

FIG. 2 illustrates a screen configuration of main web page provided from a code operating server referred to in FIG. 1;

FIG. 3 illustrates a code configuration as various examples of codes generated from the code operating server of FIG. 1;

FIGS. 4 and 5 are flowcharts illustrating operations in a code registration and operating service executed by the code operating server referred to in FIG. 1;

FIG. 6 illustrates an example of screen for a subscriber information table stored by the code operating server shown in FIG. 1;

FIG. 7 illustrates an example of virtual image screen for a code stuck to a product for sale through a code operating server shown in FIG. 1; and

FIG. 8 illustrates an example of screen for a personal code stored and indicated in a portable communication product that is for sale through a code operating server referred to in FIG. 1.

### DETAILED DESCRIPTION OF THE INVENTION

Exemplary embodiments of the invention are more fully described in detail with reference to the accompanied drawings. The invention may be embodied in many different forms and should not be construed as being limited to the exemplary embodiments set forth herein. Rather, these exemplary embodiments are provided so that this disclosure is thorough and complete, and to convey the concept of the invention to those skilled in the art.

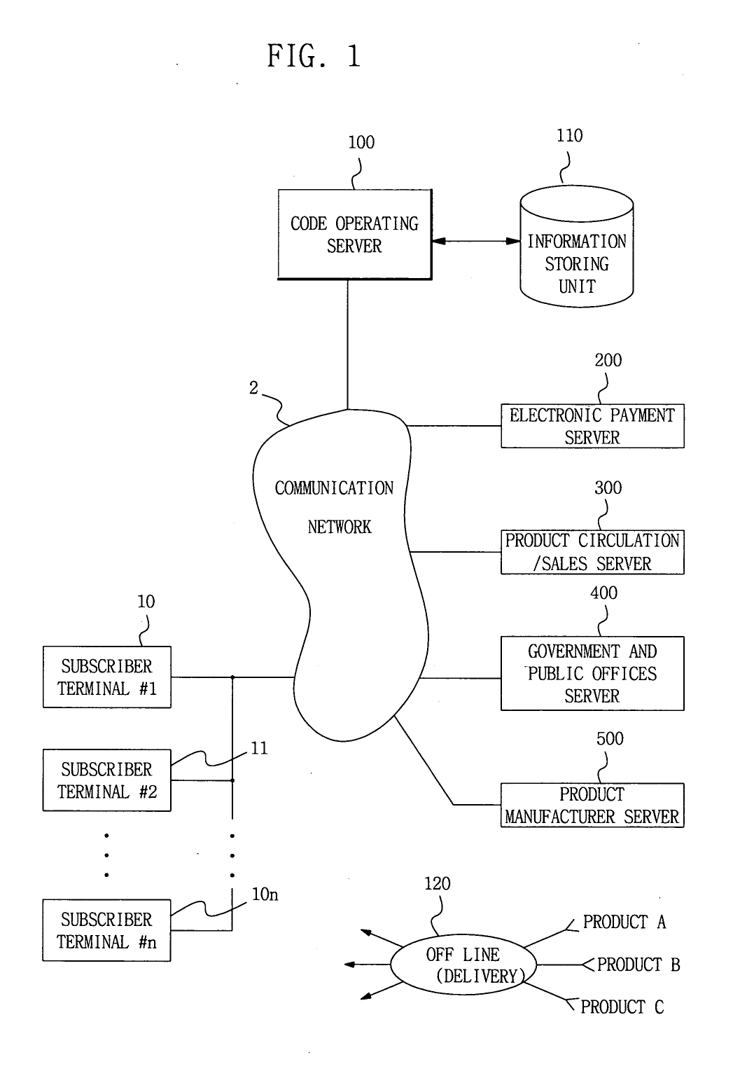

FIG. 1 is a block diagram entirely illustrating a telecommunication network system containing a code registration and service system according to an example embodiment of the present invention. Referring to FIG. 1, a code registration and service system includes a plurality of subscriber terminals 10,11,10n, a code operating server 100, an electronic payment server 200, a product circulation/sales server 300, a government and public offices server 400, a product manufacturer server 500 and information storing unit 110, which are connected with one another.

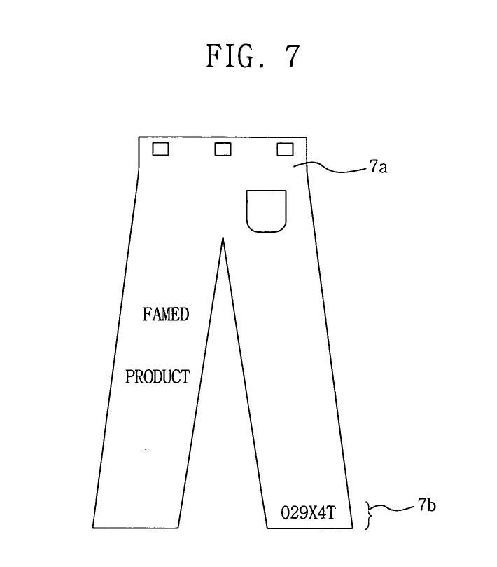

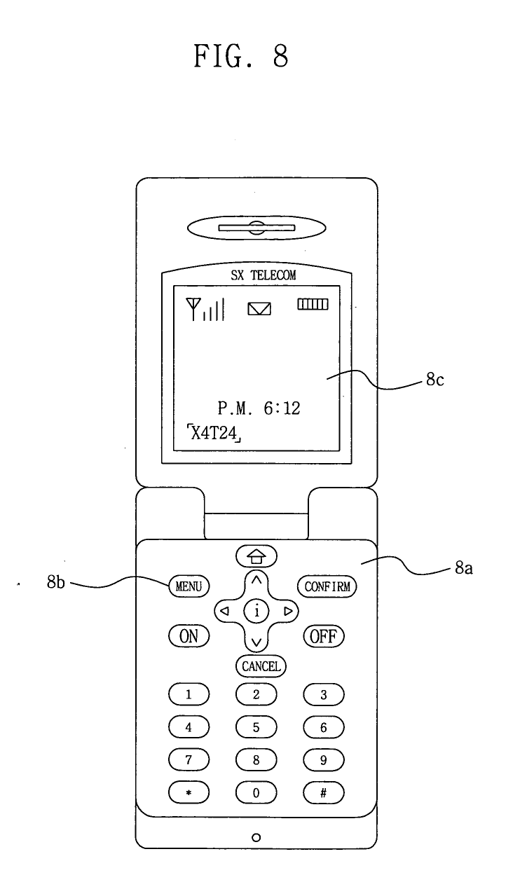

In the service system of FIG. 1, when the subscriber terminal 10 is connected to the code operating server 100 through the telecommunication network 2, the code operating server 100 first checks a code registration procedure via on line, whether there is generated a code registration request from the subscriber terminal. If the code registration request is generated, the code operating server 100 receives subscriber information and generates a personal code. When the generated personal code corresponds to a new code, the code operating server 100 performs a code registration and storage for the generated personal code. The code operating server 100 also checks as a code operating procedure, whether to apply the code to a product when an order for the product was requested from the subscriber terminal 10, and receives code registration clarification and code sticking/indication information if the code is decided to apply to the product. Then, the code operating server 100 provides a virtual image for which the code was applied to the product, through a screen, in conformity with the code sticking/indication information. When a payment for the ordered product is completed, the code operating server 100 transmits code information and information related to the code sticking/indication and manufacture to a product manufacturer server. Thus, the product manufacturer server 500 receives information of the code sticking or indication such as a coloring or a storing of data, and reflects it to a manufacture of product. When the manufacture of product is completed, the product to which the code was stuck or indicated through a RFID (radio frequency identification) method etc. is delivered to a subscriber through an off line 120, the product being, for example, clothes shown in FIG. 7 or a portable telephone shown in FIG. 8.

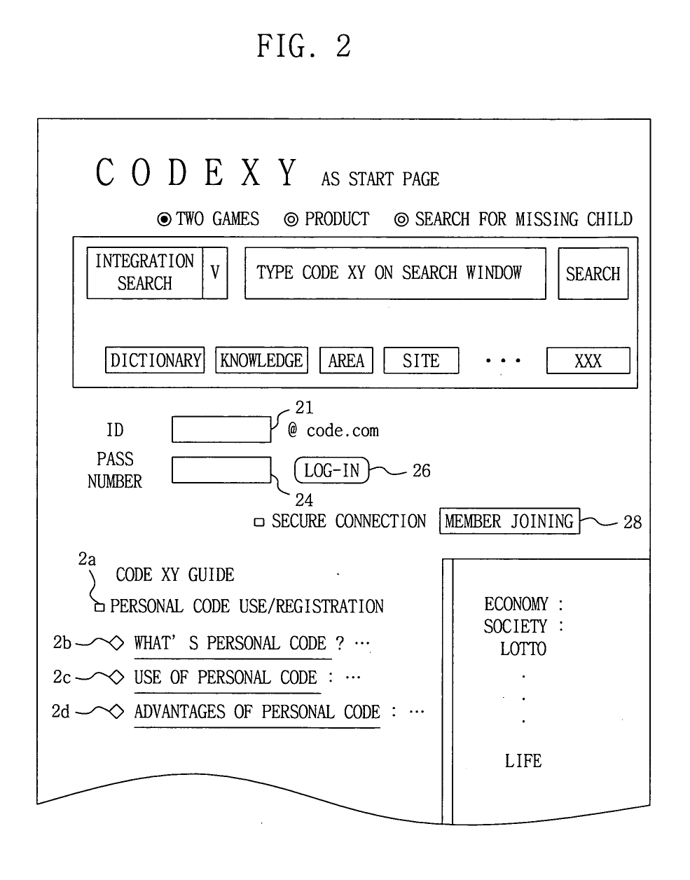

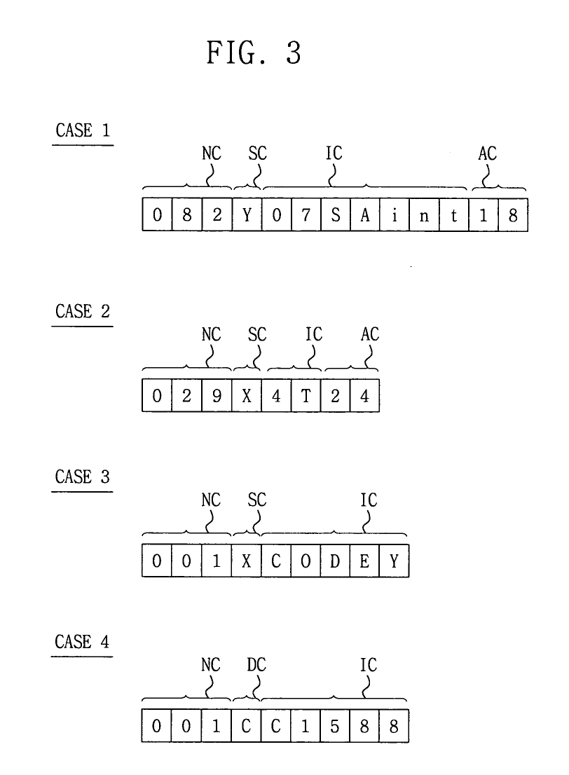

The registered personal code is configured like the system shown in FIG. 3 and this may be a uniquely existing code worldwide or domestically. Also, the registration of personal code can be obtained by executing the contents provided on a main web page as a homepage shown in FIG. 2, and then may be operated by pay after a member joining. The personal code can be used extendable to couple, family or group without limiting only to an individual.

Thus, a peculiar identification code can be properly used to an applicable thing such as famed products etc., together with substantially reducing a leakage of subscriber personal information.

In FIG. 1, the server 100 keeps a program for the code registration and operating service. The subscriber terminal 10 may be a computer that is connected to the server 100 through the telecommunication network 2 by executing an application program such as a web browser etc. The subscriber terminal may be a desktop computer, a notebook computer and a palmtop computer etc. In the information storing unit 110, various kinds of data for the subscriber information table and the code registration and operating service, which are stored by the code operating server 100, are accumulated.

Similarly, the electronic payment server 200, the product circulation/sales server 300, the government and public offices server 400 and the product manufacturer server 500 are connectable to the server 100 through the telecommunication network 2 by executing an application program necessary for the web browser or code registration and operating service. That is, the servers may be a workstation, a desktop computer or a notebook computer etc. Also, an operating system of computer may be Window XP or Linux.

The telecommunication network 2 in the example embodiment of the invention may be an Internet through which a worldwide communication connection is obtained by using a TCP/IP (Transmission Control Protocol/Internet Protocol), and may also be handheld phone, cellular phone, or mobile phone etc. which employ CDMA (code division multiple access), TDMA (time division multiple access) or IMT2000 system etc.

FIG. 2 illustrates a screen configuration of main web page provided from the code operating server shown in FIG. 1. Referring to FIG. 2, there is shown an example of homepage for the code registration and use guide. A person to subscribe therefor can see a screen as shown in FIG. 2 when connecting to the code operating server 100 through the subscriber terminal 10 shown in FIG. 1. In other words, if to desire a member joining, subscriber's information and ID and pass number are inputted by pressing a member joining icon 28. Next, a subscribed ID is inputted to an ID input window 21, and a registered pass number is inputted to a pass number input window 24. Then, the log-in is performed by pressing a login icon 26. In the meantime, before or after the member joining, the subscriber may read terms and advantages for the code use and registration through the homepage by clicking click points 2a, 2b, 2c and 2d. For example, by pressing the click point 2b it can be represented, on the screen of the subscriber terminal, a guide message as “The personal code provides a remarkable code system based on a composition of characters and digits peculiarly allocated to respective worldwide personals, couples, families or groups worldwide.” Furthermore, for example, when pressing the click point 2d, there can be represented on a screen of subscriber terminal a guide message as “The personal code provides an identification for respective personal possession goods without leaking personal information etc. such as a resident registration number etc. The personal code has advantages that if there is an inquiry request in a necessary limited case, identification through a registered code can be quick clarified under a special status such as generation of lost child, unconsciousness and death etc.”

FIG. 3 illustrates various examples of a code generation from the code operating server 100 referred to in FIG. 1. Referring to FIG. 3, a first case as “082Y07SAint18” is configured of a national code NC having 3 digits, a sexual code SC having 1 character, an identification code IC having 7 figures, and an area code AC having 2 digits. Herewith, 082 may indicate Korea, Y may indicate man, 07SAint may designate a peculiar number and 18 may designate an area, e.g., New York. The peculiar number is generated by a composition of Arabic numerals and alphabet big and small characters.

In a second case of FIG. 3, a national code NC has 3 digits, a sexual code SC has 1 character, an identification code IC has 2 figures and an area code AC has 2 digits, that is, it is represented as “029X4T24.” In a third case, a national code NC has 3 digits, a sexual code SC has 1 character, and an identification code IC has 5 characters, that is, it is represented as “001XCODEY.” In a fourth case, a national code NC has 3 digits, a group code DC has 2 characters and an identification code has 4 digits, that is, it is represented as “001CC1588.” Herewith, CC may designate a campus couple.

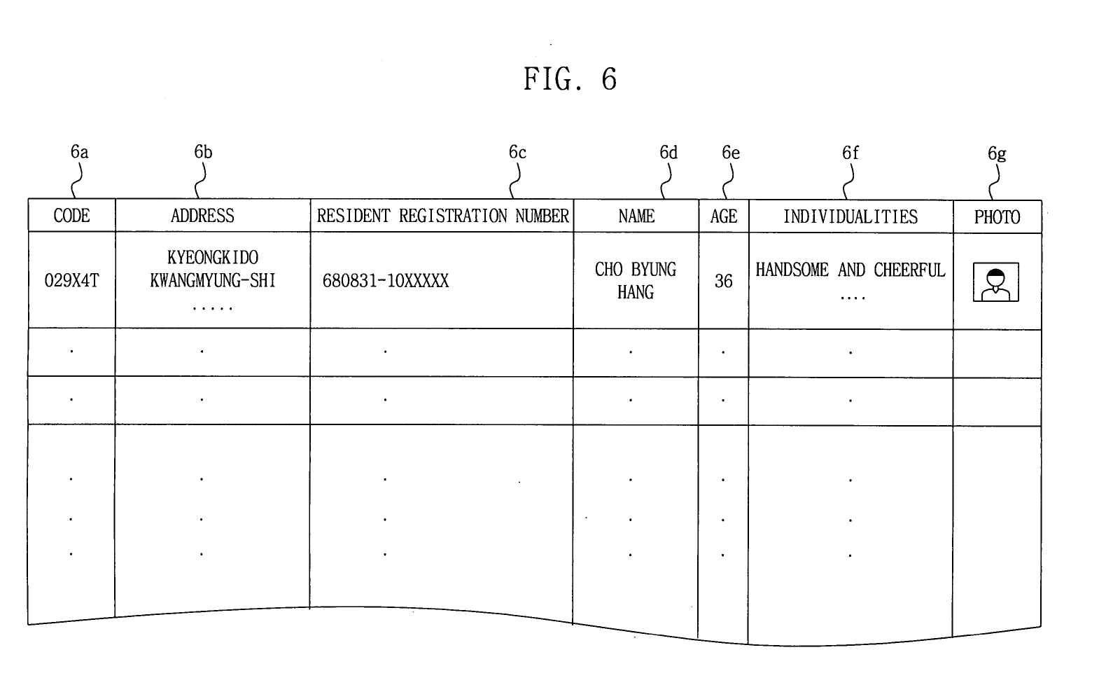

FIG. 6 illustrates an example of screen for subscriber information table stored by the code operating server referred to in FIG. 1. For example, subscriber data is stored by on order in the code system, the subscriber data being for a code sector 6a, an address sector 6b, a resident registration number sector 6c, a name sector 6d, an age sector 6e, an individuality sector 6f and a photo sector 6g. The subscriber information table is protected by an installation of fire prevention wall etc. so as to prevent an access of general people.

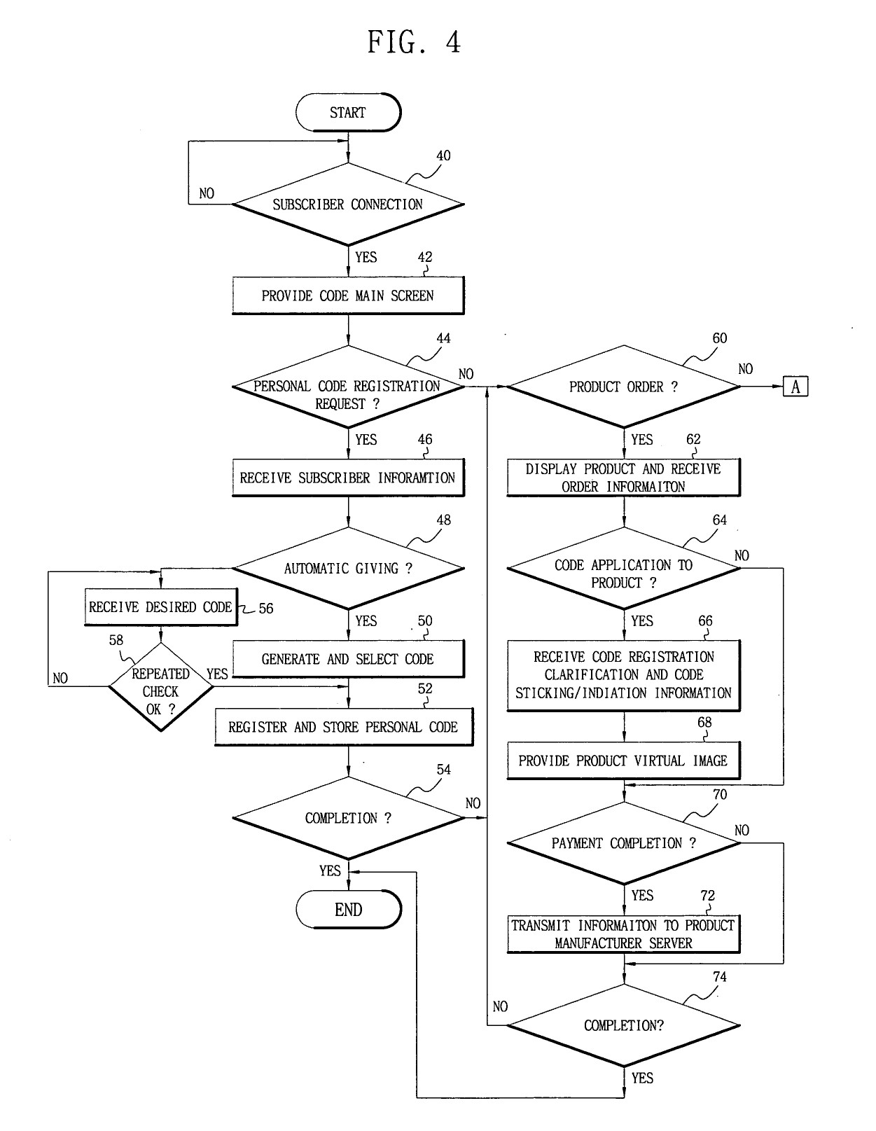

FIG. 7 illustrates an example of virtual image screen on a code to be stuck to a product for sale through the code operating server shown in FIG. 1. In FIG. 4, the subscriber can be informed in advance that on a lower edge of famed product pants selected as a product, a registration code 7b as “029X4T” is represented through the RFID system or a printing or sewing machine working etc.

FIG. 8 illustrates an example of screen for a personal code stored in and represented on a portable communication product for sale through the code operating server shown in FIG. 1. In FIG. 8, when opening a cover of portable telephone 8a of high cost selected as the product and pressing a menu button 8b thereon, a registration code as a “X4T24” is displayed on a liquid crystal display window 8c. The display of registration code can be obtained by in advance storing by a producer a peculiar registration code in a RFID chip or nonvolatile memory, e.g., a storage region of flash memory.

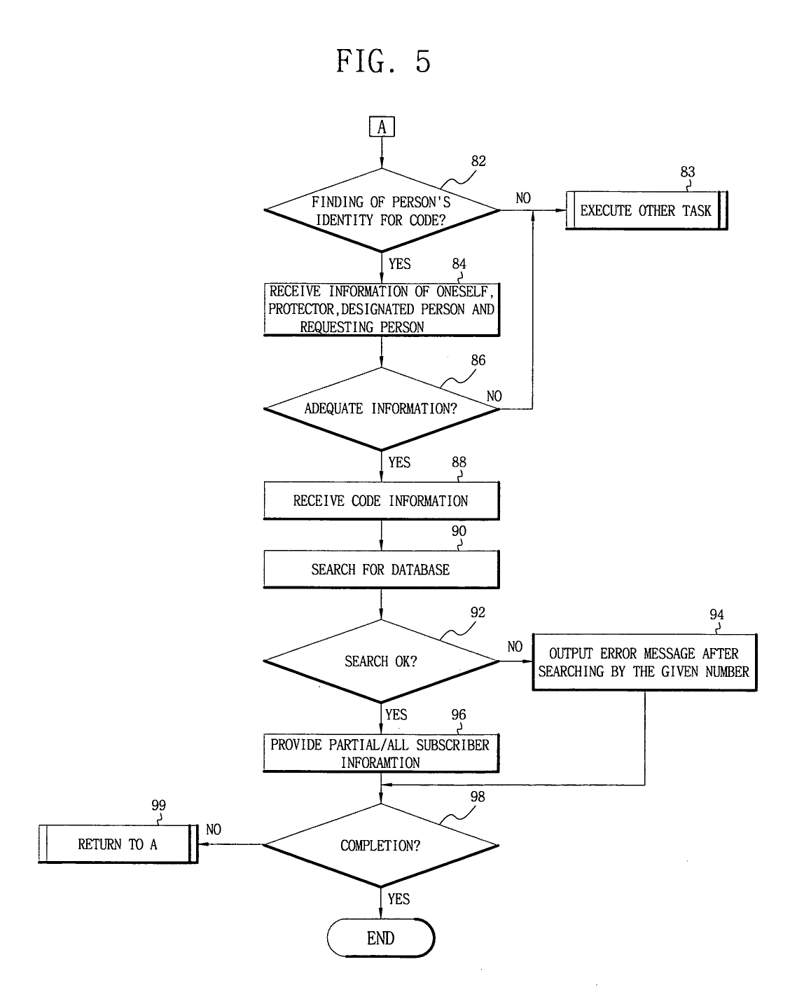

FIGS. 4 and 5 are flowcharts for operations of the code registration and use executed by the code operating server shown in FIG. 1.

Referring to FIGS. 4 and 5, operations in the example embodiments of the invention will be described as follows.

For example, when the subscriber terminal 10 of FIG. 1 is connected to the code operating server 100 through the telecommunication network 2, steps 40 and 42 in FIG. 4 are performed first. In the step 40 a subscriber connection is checked, and in the step 42, a main web page like in FIG. 2, e.g., homepage, for the code registration and use, is provided to a screen of the subscriber terminal 10. When there is a registration requirement of personal code in a step 44, subscriber information is received in a step 46. It is decided in a step 48 whether to require an automatic or manual giving of code. If the automatic giving of code is required, a code generation and selection is performed in a step 50. Herewith, the selection indicates that the subscriber selects one among a plurality of codes after generating the plurality of codes.

In the manual giving of code, a desired code is received in a step 56, and it is checked whether the code is repeated, in a step 58. When the code is not repeated or the step 50 is performed, a personal code registration and storage is performed in a step 52. The configuration of code system was already described with reference to FIG. 3 and the storage of code was also described with reference to FIG. 6.

If not for the end of operations in a step 54 or there is not the code registration request in the step 44, it is checked in a step 60 whether there is an order for a product. At this time, when an icon for an order of product is clicked through a link with the product circulation/sales server 300, a display of corresponding product is performed in a step 62, and a connected subscriber can see the product on screen and order information is received thereto. This order information contains personal information of ordering person and delivery place information such as an address etc.

In a step 64 it is decided whether to apply the code to the selected product. If the code is applied thereto, steps 66, 68, 70 and 72 are performed. In the step 66, code registration clarification and code sticking/indication information are received in case the code is applied to the product. In the step 68, a virtual image that the code was applied to the product is provided through the screen in compliance with the received sticking/indication information. Thus, the screen like FIG. 7 or 8 may be provided. The configuration of screen is provided automatically by a web design of servers linked with a program determined in the server 100, and the contents in the screen configuration may be changed according to some necessity at any time.

In the step 70 it is checked for a payment completion through a link with the electronic payment server 200. In the step 72, code information and information related to the code sticking/indication and manufacture is transmitted to the product manufacturer server 500 when the payment for the ordered product is completed. The payment may be generally progressed through a deferred payment using a credit card etc. and through an advance payment of paying by cash via on line.

As described above, in case the registered personal code is represented on the product through the RFID method etc., peculiarity and difference for possessed goods are provided worldwide, thus a sales promotion of product or brand image is enhanced. In addition, in case the possession goods are lost or robbed, a recovery possibility therefor can be increased. In case the code is applied to the product, identification for possessed goods is easy, thereby substantially reducing a loss probability through a theft.

If it is required to clarify identification for the code stuck to or indicated on the product from the subscriber terminal or government and public offices server 400, a step 82 of FIG. 5 is performed. When a search for the code identification is required, information of oneself, protector, designated person or requesting person is received in a step 84, which is provided to check in a step 86 whether to be proper to a requirement of the requesting person. Herewith, the identification information contains at least one among address, resident registration number, name and photo information.

When the search is performed in a step 92, a step 96 is executed, to provide portion or all of the subscriber information searched according to a security grade of an inquiry requiring person to the screen of requiring person. For instance, if the security grade was decided low, only a photo of the code registrant may be provided to the screen of inquiry requiring person.

Therefore, even though a special status like generation of missing child, death, unidentified or unconscious state is caused, an identification clarification can be promptly obtained through the code operating server.

The invention may be desirable embodied with codes readable by a computer in recording media readable by a computer. The recording media readable by the computer contain all kinds of recording devices in which data readable by a computer is stored.

As an example of the recording media readable by the computer, there are ROM, RAM, CD-ROM, magnetic tape, floppy disk, optical data storing device or RFID etc., and there is also contained an embodiment as a carrier wave type, for example, a transmission through Internet. In addition, the recording media readable by the computer are dispersing disposed in a computer system connected through a network, thus codes readable by the computer through a dispersion scheme may be stored and executed.

As described above, the inventive system and method substantially reduce a leakage of personal information and simultaneously apply peculiar identification codes to adequate things.

Therefore, in representing a registered personal code on a product, peculiarity and difference for possession goods can be provided under a worldwide environment, thereby enhancing a sales promotion or brand image and increasing a recovery probability for lost or robbed possession goods.

In addition, subscriber information can be grasped only in an extremely limited case, through codes represented on the possession goods, thus an identification clarification can be promptly obtained through a code operating server when a special status like generation of missing child, death, unidentified or unconscious state etc. is caused.

It will be apparent to those skilled in the art that modifications and variations can be made to the exemplary embodiments without deviating from the spirit or scope of the invention. Thus, it is intended that the invention cover any such modifications and variations of this invention provided they come within the scope of the appended claims and their equivalents. For example, a systematic configuration for registration scheme and code operation, or a service control sequence, etc. can be varied diversely. Accordingly, these and other changes and modifications are seen to be within the true spirit and scope of the invention as defined by the appended claims.

I claim:

1. A method of registering a personal code through a telecommunication network, comprising:
checking whether there is generated a code registration request from a subscriber terminal connected to the telecommunication network, the code registration request being for requesting a registration of code to be used for an indication of possession;
receiving subscriber information if the code registration request was generated, and automatically or manually generating the personal code conformed to a predetermined certification format; and
performing a code registration and storage for the generated personal code if the generated personal code corresponds to a new code.

2. The method as claimed in 1, wherein the registered personal code exists uniquely worldwide or domestically, and is obtained by a composition of national code, sexual code and identification code.

3. The method as claimed in 1, wherein the registration of personal code is operated through a member joining by pay or by free.

4. The method as claimed in 1, wherein the personal code is readable by a RFID (radio frequency identification) system and is provided for an identification of goods that is possessed by at least one among personal, couple, family or group.

5. A method of registering and operating a personal code through a telecommunication network, comprising:
checking whether there is generated a code registration request from a subscriber terminal connected to the telecommunication network, the code registration request being for requiring a registration of code representing a possession;
receiving subscriber information when the code registration request is generated, and automatically or manually generating a code conformed to a certification format;
performing a code registration and storage for the generated code if the generated code corresponds to a new code;
checking whether to apply the code to a product when an order for the product is requested from the subscriber terminal;
receiving a code registration clarification and code sticking/indication information if the code is applied to the product;
providing a virtual image for which the code was applied to the product, through a screen, in compliance with the code sticking/indication information; and
transmitting code information, and information related with the code sticking/indication and manufacture, to a product manufacturer server, when a payment for the ordered product was completed.

6. The method as claimed in 5, wherein the order for products is applicable to all goods for sale through Internet.

7. The method as claimed 6, wherein the registered code is basically configured of national code, sexual code and identification code.

8. The method as claimed 7, wherein the registered code further contains an area code.

9. A personal code registration and service system through a telecommunication network, comprising:
a subscriber terminal connected through the telecommunication network; and
a code registering server, wherein the code registering server:
checks through the telecommunication network via on line, whether there is generated a code registration request from the subscriber terminal, the code registration request being for requiring a registration of code to be used to represent a possession;
receives subscriber information when the code registration request is generated, and generates a personal code conformed to a certification format; and
performing a code registration and storage for the generated personal code only in case the generated personal code corresponds to a new code.

10. The system as claimed in 9, further comprising an information storing unit that is connected to the code registering server and that stores subscriber data for the code registration and storage.

11. The system as claimed in 10, wherein the registered personal code uniquely exists domestically or domestically.

12. The system as claimed in 11, wherein the personal code conformed to the certification format is configured by a composition of national code, sexual code and identification code.

13. The system as claimed in 12, wherein the personal code is generated automatically or manually, and in the manual generation thereof, a subscriber selects one among a plurality of desired codes by receiving the plurality of desired codes.

14. The system as claimed in 10, further comprising a code operating server connected to the code registering server, the code operating server being for performing a code registration and storage, and then, receiving code registration clarification and code sticking/indication information when an order of product for a code application is requested, and for providing a virtual image through a screen, and for transmitting code information, and information related with the code sticking and indication and manufacture, to a product manufacturer server.

15. The system as claimed in 14, wherein the code sticking/indication is executed through recording media such as RFID (radio frequency identification), semiconductor memory or bar code etc.
